(19) United States
(12) Patent Application Publication
(10) Pub. No.: US 2026/0010757 A1
(43) Pub. Date: Jan. 8, 2026

(54) WELLBORE LOG-BASED MACHINE LEARNING USING A FOUNDATIONAL MODEL

(71) Applicant: Schlumberger Technology Corporation, Sugar Land, TX (US)

(72) Inventors: Vanessa SIMOES, Houston, TX (US); Hiren Maniar, Houston, TX (US); Aria Abubakar, Houston, TX (US); Tao Zhao, Houston, TX (US)

(21) Appl. No.: 19/134,717

(22) PCT Filed: Dec. 1, 2023
(86) PCT No.: PCT/US2023/082115

§ 371 Date: May 31, 2025

Related U.S. Application Data
(60) Provisional application No. 63/385,704, filed on Dec. 1, 2022.

(51) Int. Cl. G06N 3/042; G06N 3/0464; G06N 3/0895; G06N 3/096

(52) U.S. Cl. CPC G06N 3/042; G06N 3/0464; G06N 3/0895; G06N 3/096

(57) ABSTRACT

Systems and methods of the present disclosure provide systems and methods related to using foundational model(s) for wellbore applications. The foundational model(s) may be constructed using a deep learning model with high capacity to train using data at scale. Additionally, the foundational model(s) may be constructed from such well logs containing unlabeled data and may be constructed using self-supervised approaches. The foundational model is generalized and suitable for performing multiple downstream tasks/applications using the foundational model.

### CROSS-REFERENCE TO RELATED APPLICATIONS

This application claims priority to U.S. Provisional Patent Application No. 63/385,704, filed on Dec. 1, 2022, which is incorporated herein by reference in its entirety.

### FIELD

The present disclosure relates to systems and methods for constructing and using foundational model-based machine learning for different types of downstream applications/tasks.

### BACKGROUND INFORMATION

Wellbores in downhole wells have complex and varied surroundings. Thus, applying machine learning to wellbore log-related applications may be difficult due to such high complexity and due to the diversity of the subsurface. Additionally, machine learning may be difficult to deploy in wellbore log-related applications due to the difficulty and high costs associated with getting training data labeled properly. Furthermore, in wellbore log-related applications, some common challenges when developing machine learning based solutions include the high complexity and diversity of the subsurface, high costs associated in getting training label data, input wellbore logs with low quality intervals and inconsistent data, and one or more missing log types in each interval of a log.

The current approaches for machine learning consist of building machine learning models to solve one specific task for a particular location. Training those models involves extensive dedication from domain experts to select, clean, and label (interpret) the dataset and extensive dedication from data scientists and high computational costs to fine-tune and train a model. While building a deep learning model using conventional approaches includes a large, labeled dataset, and human and computational resources, the resulting model is not generalizable for other tasks or geologies and may be performed from scratch for different tasks. Furthermore, bearing in mind the multitude of wellbore log workflows, building, and maintaining individual deep learning models can be cumbersome, and potentially error prone. Furthermore, the processing/connectivity available at or near oilfields may be relatively small due to the remote locations. Thus, in such locations, the processing is to rely on smaller amounts of labelled training data that may be performed more quickly and/or with less processing power than may be available in data centers or other processing centers due to the limited processing and/or connectivity from the oilfield.

Furthermore, this complication may be exacerbated by the likelihood of input wellbore logs with low quality and/or inconsistent data (e.g., missing, incorrect, or mislabeled data) for different intervals of a wellbore traversal in a well log using a downhole tool. In fact, the wellbore log data may even be missing one or more log types in different intervals of a wellbore traversal using the downhole tool. As such, a solution is needed to provide the ability to perform wellbore log processing with limited numbers of inputs, low-quality data, inconsistent data, mislabeled log data, a limited amount of processing, and/or a limited amount of connectivity that may be available in an oilfield.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method including obtaining unlabeled log data from a plurality of wellbores and constructing a foundational model from the unlabeled log data. The method also includes fine-tuning the foundational model that can be performed by adapting the entire foundational model or a subset of layers of the model, as well as, keeping the entire model frozen and adding additional layers or trainable parameters to solve for a downstream application or a plurality of downstream applications performable using the foundational model. Further, the method includes implementing the downstream application of the plurality of downstream applications based at least in part on the foundational model.

In addition, certain embodiments of the present disclosure include a method including obtaining unlabeled data from a plurality of tasks used on well log data of a plurality of well log types and constructing a foundational model from the unlabeled data. The method also includes fine-tuning or other techniques to adapt the foundational model for a task or a plurality of tasks performable using the foundational model. Further, the method includes implementing the task of the plurality of tasks based at least in part on the foundational model.

Further, certain embodiments of the present disclosure include a system including memory storing instructions. The system also includes a processor configured to execute the instructions to cause the processor to receive a foundational model that is based at least in part on unlabeled log data from a plurality of wellbores. The processor is also configured to execute the instructions to cause the processor to receive, via one or more sensors, well log data from a well. Further, the processor is configured to execute the instructions to cause the processor to, using the foundational model, cause a downstream application or a plurality of downstream applications implementable using the foundational model to be implemented.

In an embodiment of systems and methods for constructing and using foundational model-based machine learning for different types of downstream applications/tasks, a method for implementing one or more downstream applications is presented. This method comprising: (i) obtaining unlabeled log data from a plurality of wellbores, the unlabeled log data includes data from a plurality of different log types comprising at least one of gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, photoelectric (PEF) logs, or any combination thereof; (ii) constructing a foundational model from the unlabeled log data, the foundational model utilizing a neural network to perform machine learning using self-supervised training, wherein the self-supervised training comprises transforming the unlabeled log data, constructing the foundational model also comprises utilizing a high-capacity deep learning model that includes a plurality of convolutional layers; (iii) fine-tuning the foundational model for the one or more downstream applications performable using the foundational model, wherein the downstream application comprising at least one of an outlier detection operation, a log correction application to correct log data by identifying mislabeling in the additional well log data, a formation property determination of a formation around a well corresponding to the unlabeled log data, determining areas of interest in the formation, marking areas of interest in the formation, or predicting missing log data from the unlabeled log data; and (iv) implementing the one or more downstream applications based at least in part on the foundational model. This embodiment may also include displaying the fine-tuned foundational model, generating or transmitting a control signal in response to the fine-tuned foundational model, wherein the control signal causes a physical wellsite action to occur and performing the physical wellsite action in response to the control signal.

In an alternative embodiment of systems and methods, a method is presented for optimizing one or more downstream applications. The method includes obtaining unlabeled log data from a plurality of wellbores and constructing a foundational model from the unlabeled log data. The foundational model comprises a neural network to perform machine learning using self-supervised training, wherein the self-supervised training includes transforming the unlabeled log data. The method includes fine-tuning the foundational model for the one or more downstream applications, wherein the downstream application is performable using the foundational model. The method also includes implementing the one or more downstream applications based at least in part on the foundational model.

In the above described method embodiment, the unlabeled log data may comprise log data from one or more of the following sources: gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, photoelectric (PEF) logs. The method may include any combination of these sources. In the method, transforming the unlabeled log data may include adding noise to the unlabeled log data or, alternatively, applying controlled distortion to the unlabeled log data. Both adding noise and applying controlled distortion may done in combination. Further to this method, constructing the foundational model may comprise utilizing a high-capacity deep learning model that includes a plurality of convolutional layers, e.g., twenty or more convolutional layers may be used. The method may include the one or more of the following downstream applications: an outlier detection operation, a log correction application to correct log data by identifying mislabeling in the additional well log data, a formation property determination of a formation around a well corresponding to the unlabeled log data, determining areas of interest in the formation, marking areas of interest in the formation, or predicting missing log data from the unlabeled log data.

In the above embodiment, the method may include fine-tuning the foundational model. This fine tuning may include imposing constraints on the foundational model. Transforming the unlabeled log data in the above method may include adding noise to the unlabeled log data and/or applying controlled distortion to the unlabeled log data. This embodiment may also include displaying the fine-tuned foundational model, generating or transmitting a control signal in response to the fine-tuned foundational model, wherein the control signal causes a physical wellsite action to occur and performing the physical wellsite action in response to the control signal.

Another alternative embodiment of a method for improved implementation of one or more downstream applications is presented that comprises obtaining unlabeled log data that includes one or more of gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, photoelectric (PEF) logs. The method includes constructing a foundational model from the unlabeled log data, wherein the foundational model comprises a neural network to perform machine learning using self-supervised training and then fine-tuning the foundational model for the one or more downstream applications, wherein the downstream application is performable using the foundational model. The method also includes implementing the one or more downstream applications based at least in part on the foundational model. In this embodiment of the method the self-supervised training includes transforming the unlabeled log data. This transforming may include one or both of adding noise to the unlabeled log data and applying controlled distortion to the unlabeled log data. In this embodiment, constructing the foundational model may also comprise utilizing a high-capacity deep learning model that includes a plurality of convolutional layers, e.g., twenty or more convolutional layers. The method includes downstream applications comprise one or more of an outlier detection operation, a log correction application to correct log data by identifying mislabeling in the additional well log data, a formation property determination of a formation around a well corresponding to the unlabeled log data, determining areas of interest in the formation, marking areas of interest in the formation, or predicting missing log data from the unlabeled log data. This method may also have fine-tuning that includes imposing constraints on the foundational model. This embodiment may also include displaying the fine-tuned foundational model, generating or transmitting a control signal in response to the fine-tuned foundational model, wherein the control signal causes a physical wellsite action to occur and performing the physical wellsite action in response to the control signal.

### BRIEF DESCRIPTION OF THE DRAWINGS

Various aspects of this disclosure may be better understood upon reading the following detailed description and upon reference to the drawings, in which:

FIG. 1 illustrates a diagram of a data capturing system used to capture data in and/or around an oilfield, in accordance with embodiments of the present disclosure;

FIG. 2 illustrates a computing system used to process data from the data capturing system of FIG. 1, in accordance with embodiments of the present disclosure;

FIG. 3A illustrates a process for operating the computing system of FIG. 2, in accordance with embodiments of the present disclosure;

FIG. 3B illustrates details of the block 294 process of FIG. 3A, in accordance with embodiments of the present disclosure;

FIG. 4 illustrates a diagram showing construction of a foundational model from the captured data of FIG. 1 and use of the foundational model in one or more downstream applications of multiple different types of one or more downstream application types, in accordance with embodiments of the present disclosure; and

FIG. 5 illustrates a diagram showing construction of a foundational model from downstream applications of FIG. 4 and use of the foundational model in one or more future downstream applications, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

The embodiments described herein include systems and methods related to using foundational model(s) for wellbore applications. As discussed below, foundational model(s) are constructed using a deep learning model with high capacity to train using data at scale. For instance, high capacity may include 5, 10, 15, 20, or more processing layers (e.g., convolutional layers, fully connected layers) along with support layers (e.g., multiplexing layers). Accordingly, the foundational model(s) may be constructed using well logs of multiple types from multiple wellbores at multiple locations. The foundational model may be constructed from such well logs containing unlabeled data and may be constructed using self-supervised approaches. Unlabeled data refers to data elements lacking, either completely or substantially, distinct identifiers or classifications. That is, the data lack some or all “tags” or “labels” indicative of characteristics or qualities thereof. In self-supervised learning, the pre-training task is derived from the unlabeled data. Yet, their value is irrefutable in scenarios where exploration, rather than direction, is the primary aim. Thus, more data makes foundational model(s) more robust as the self-supervised tasks are scalable with the data. The self-supervised training forces the foundational model to predict parts of the inputs (e.g., missing data from well logs). The foundational model is generalized and suitable for performing multiple downstream tasks/applications using the foundational model. The generalization of the foundational model provides a head start when one of these multiple downstream tasks/applications is to be performed. In other words, the performance of any of the downstream tasks/applications may use less computational time and/or resources than if performed without the foundational model. Indeed, the performance of any of the downstream tasks/applications may converge more quickly using less data inputs, less computing time, and/or less computational power than if the downstream task/application were performed directly from data rather than using the foundational model. Thus, such tasks may be performed using the foundational model at remote locations (e.g., oilfields) where access to more high-powered computing resources (e.g., clouds and/or servers) may be unavailable due to relatively poor connectivity to such resources. Performing such remote computations may be impractical/impossible without using the foundational model. Additionally or alternatively to constructing the foundational model from multiple well log types from multiple wells, the foundational model may be constructed from data from previous downstream tasks/application and used for future downstream tasks/applications.

### Data Capturing System

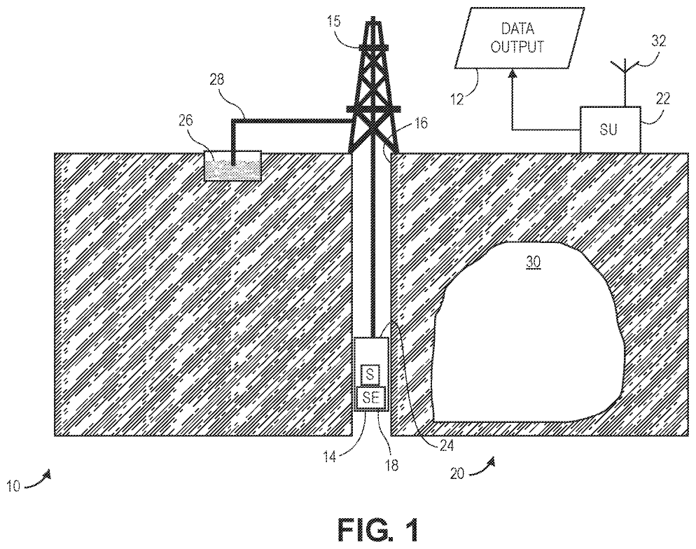

With the foregoing in mind, FIG. 1 illustrates a data capturing system 10 to capture and produce data output 12 in an oilfield that is captured as part of a wireline operation, pumping operation, drilling operation, extraction operation, or any other operation being performed. In the illustrated embodiment, the data capture is being at least partially performed by a wireline tool 14 suspended by a rig 15 and into a wellbore 16. The wireline tool 14 is adapted for deployment into wellbore 16 for generating well logs, performing downhole tests, collecting samples, and/or collecting any other data. For instance, the wireline tool 14 may assist in performing a seismic survey operation. Additionally or alternatively, the wireline tool 14 may, for example, have an explosive, radioactive, electrical, or acoustic energy source 18 that sends and/or receives electrical signals to surrounding subterranean formations 20 and/or fluids therein. Return signals may be detected using the wireline tool 14 and/or other tools located at other locations at/near the oilfield.

Computer facilities may be positioned at various locations about the oilfield (e.g., the surface unit 22) and/or at remote locations. The surface unit 22 may be used to communicate with the wireline tool 14 and/or offsite operations, as well as with other surface or downhole sensors. The surface unit 22 is capable of communicating with the wireline tool 14 to send commands to the wireline tool 14 and to receive data from the wireline tool 14. The surface unit 22 may also collect data generated during the drilling operation and/or logging and produces data output 12, which may then be stored or transmitted. In other words, the surface unit 22 may collect data generated during the wireline operation and may produce data output 12 that may be stored or transmitted. The wireline tool 14 may be positioned at various depths in the wellbore 16 to provide a survey or other information relating to the subterranean formation 20. In some embodiments, the surface unit 22 may include any suitable device, such as a geophone, a seismic truck, a computer, and/or other suitable devices.

The surface unit 22 may include one or more various sensors and/or gauges that may additionally or alternatively be located at other locations in the oilfield. These sensors and/or gauges may be positioned about the oilfield (e.g., in/at the rig 15) to collect data relating to various field operations. As shown, at least one downhole sensor 24 is positioned in the wireline tool 14 to measure downhole parameters which relate to, for example porosity, permeability, fluid composition and/or other parameters of the field operation. During drilling, one or more parameters, such as weight on bit, torque on bit, pressures, temperatures, flow rates, compositions, rotary speed, and/or other parameters of the field operation, may be measured.

The surface unit 22 may include a transceiver 32 to enable communications between the surface unit 22 and various portions of the oilfield or other locations. The surface unit 22 may also be provided with or functionally connected to one or more controllers for actuating mechanisms at the oilfield. The surface unit 22 may then send command signals to the oilfield in response to data received. The surface unit 22 may receive commands via the transceiver 32 or may itself execute commands to the controller. A computing system including a processor may be provided to analyze the data (locally or remotely), make decisions, control operations, and/or actuate the controller. In this manner, the oilfield may be selectively adjusted based on the data collected. This technique may be used to enhance portions of the field operation, such as controlling drilling, weight on bit, pump rates, and/or other parameters. These adjustments may be made automatically based on an executing application with or without user input.

As previously noted, at least some of the data output 12 may be captured during drilling such that the wireline tool 14 is replaced and/or supplemented by drilling tools suspended by the rig 15 and advanced into the subterranean formations 20 to form the wellbore 16. A mud pit 26 is used to draw drilling mud into the drilling tools via flow line 28 for circulating drilling mud down through the drilling tools, then up wellbore 16 and back to the surface. The drilling mud may be filtered and returned to the mud pit 26. A circulating system may be used for storing, controlling, or filtering the flowing drilling muds. The drilling tools are advanced into subterranean formations 20 to reach a reservoir 30. Each well may target one or more reservoirs. The drilling tools are adapted for measuring downhole properties using logging while drilling tools. The logging while drilling tools may also be adapted for taking core samples.

Drilling tools may include a bottom hole assembly, generally referenced, near the drill bit (e.g., within several drill collar lengths from the drill bit). The bottom hole assembly includes capabilities for measuring, processing, and storing information, as well as communicating with the surface unit 22. The bottom hole assembly further includes drill collars for performing various other measurement functions.

The bottom hole assembly/wireline tool 14 may include a communication subassembly that communicates with the surface unit 22. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured parameters. It will be appreciated by one of skill in the art that a variety of telemetry systems may be employed, such as wired drill pipe, electromagnetic, or other known telemetry systems.

Generally, the wellbore 16 is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also be adjusted as new information is collected.

The data gathered by sensors 24 may be collected by the surface unit 22 and/or other data collection sources for analysis or other processing. The data collected by the sensors 24 may be used alone or in combination with other data. The data may be collected in one or more databases and/or transmitted to another location on-site or off-site. The data may be historical data, real time data, or combinations thereof. The real time data may be used in real time, or stored for later use. The data may also be combined with historical data and/or other inputs for further analysis. The data may be stored in separate databases and/or combined into a single database.

### Computing System

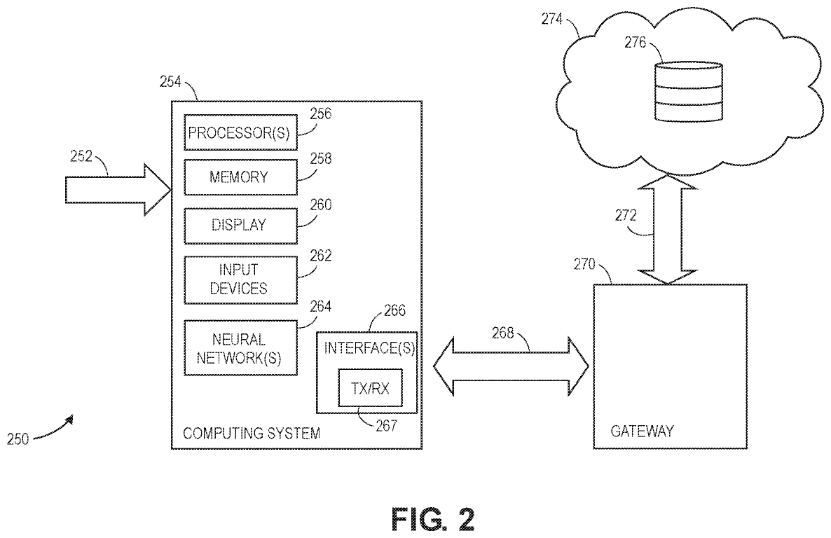

FIG. 2 is a block diagram of a system 250 that may be used for analyzing/utilizing the data output 12 from the data capturing system 10, as described in FIG. 1. The data output 12, as described in FIG. 1, is received as input data 252 at a computing system 254. The computing system 254 may be implemented in the surface unit 22 and/or may be implemented at other locations within the oilfield or remotely from the oilfield where the remote locations are able to receive the data via the transceiver 32. The various functional blocks shown in FIG. 2 may include hardware elements (including circuitry), software elements (including computer code stored on a tangible computer-readable medium), or a combination of both hardware and software elements. It should be noted that FIG. 1 is merely one example of a particular implementation and is intended to illustrate the types of components that may be present in the computing system 254.

As illustrated, the computing system 254 includes one or more processor(s) 256, a memory 258, a display 260, input devices 262, one or more neural networks(s) 264, and one or more interface(s) 266. In the computing system 254, the processor(s) 256 may be operably coupled with the memory 258 to facilitate the use of the processors(s) 256 to implement various stored programs. Such programs or instructions executed by the processor(s) 256 may be stored in any suitable article of manufacture that includes one or more tangible, computer-readable media at least collectively storing the instructions or routines, such as the memory 258. The memory 258 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor(s) 256 to enable the computing system 254 to provide various functionalities.

The input devices 262 of the computing system 254 may enable a user to interact with the computing system 254 (e.g., pressing a button to increase or decrease a volume level). The interface(s) 266 may enable the computing system 254 to interface with various other electronic devices. The interface(s) 266 may include, for example, one or more network interfaces for a personal area network (PAN), such as a Bluetooth network, for a local area network (LAN) or wireless local area network (WLAN), such as an IEEE 802.11x Wi-Fi network or an IEEE 802.15.4 wireless network, and/or for a wide area network (WAN), such as a cellular network. The interface(s) 266 may additionally or alternatively include one or more interfaces for, for example, broadband fixed wireless access networks (WiMAX), mobile broadband Wireless networks (mobile WiMAX), and so forth.

In certain embodiments, to enable the computing system 254 to communicate over the aforementioned wireless networks (e.g., Wi-Fi, WiMAX, mobile WiMAX, 4G, LTE, and so forth), the computing system 254 may include a transceiver (Tx/Rx) 267. The transceiver 267 may include any circuitry that may be useful in both wirelessly receiving and wirelessly transmitting signals (e.g., data signals). The transceiver 267 may include a transmitter and a receiver combined into a single unit.

The input devices 262, in combination with the display 260, may allow a user to control the computing system 254. For example, the input devices 262 may be used to control/initiate operation of the neural network(s) 264. Some input devices 262 may include a keyboard and/or mouse, a microphone that may obtain a user's voice for various voice-related features, and/or a speaker that may enable audio playback. The input devices 262 may also include a headphone input that may provide a connection to external speakers and/or headphones.

The neural network(s) 264 may include hardware and/or software logic that may be arranged in one or more network layers. In some embodiments, the neural network(s) 264 may be used to implement machine learning and may include one or more suitable neural network types. For instance, the neural network(s) 264 may include a perceptron, a feed-forward neural network, a multi-layer perceptron, a convolutional neural network, a long short-term memory (LSTM) network, a sequence-to-sequence model, and/or a modular neural network. In some embodiments, the neural network(s) 264 may include at least one deep learning neural network.

The neural network(s) 264 may include foundational model(s). Foundational model(s) are deep large-capacity neural networks trained using unsupervised or self-supervised training. Further, once trained or “pre-trained,” such model(s) may be employed for multiple downstream tasks by refining or “fine-tuning” the foundational model using a few representative labels.

The output of the neural network(s) 264 may be based on the input data 252, such as one or more wellbore logs from a plurality of well locations. This output may be used by the computing system 254. Additionally or alternatively, the output from the neural network(s) 264 may be transmitted using a communication path 268 from the computing system 254 to a gateway 270. The communication path 268 may use any of the communication techniques previously discussed as available via the interface(s) 266. For instance, the interface(s) 266 may connect to the gateway 270 using wired (e.g., Ethernet) or wireless (e.g., IEEE 802.11) connections. The gateway 270 couples the computing system 254 to a wide-area network (WAN) connection 272, such as the Internet. The WAN connection 272 may couple the computing system 254 to a cloud network 274. The cloud network 274 may include one or more computing systems 254 grouped into one or more locations (e.g., data centers). The cloud network 274 includes one or more databases 276 that may be used to store the output of the neural network(s) 264. In some embodiments, the cloud network 274 may perform additional transformations on the data using its own processor(s) 256 and/or neural network(s) 264.

To address the challenges in performing log analysis using machine learning, a foundational model may provide a more unified and convenient deployment of workflows using a variety of unlabeled data and a variety of tasks. By training with a variety of unlabeled data and a variety of tasks, the features extracted are more complete and suitable for the different tasks where the model is steered towards better generalization capabilities to robustly address downstream tasks. Also, fine-tuning the downstream tasks from a pre-trained foundational model will greatly accelerate the training process, involve fewer training labels, and further, potentially also reduce the risk of overfitting. Thus, building a broadly applicable machine learning solution (e.g., foundation model) is capable of simultaneously handling the high complexity of the subsurface while the eventual usage for more narrow downstream tasks uses smaller amounts of labelled training data that may be performed more quickly and/or with less processing power than used to form the foundational model or to perform the downstream task from wellbore logs without the foundational model. This smaller amount of data may be beneficial since processing and/or connectivity from an (surface unit 22 of an) oilfield may be limited. Using a common foundational model at least partially addresses the difficulties in utilizing machine learning for wellbore log-related applications. A further benefit of using foundational model(s) is the ability to generalize the solution across different oilfields, different wellbores, different acquisition tools, geographic locations, and the ability to be incorporated into multiple different types of downstream tasks related to the wellbore logs. When building a common foundational model that captures the representation of the data, generalizes this representation across oilfields, and has enough information to address multiple downstream tasks, the focus may be on transfer learning and reusability to reduce the complexity and time associated with each downstream application and for application in new geographical regions.

### Illustrative Process

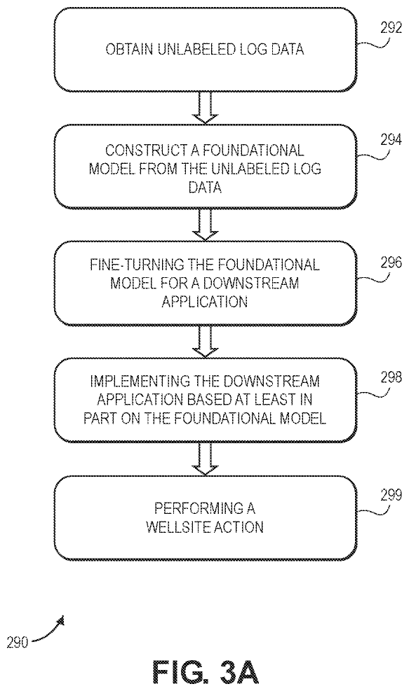

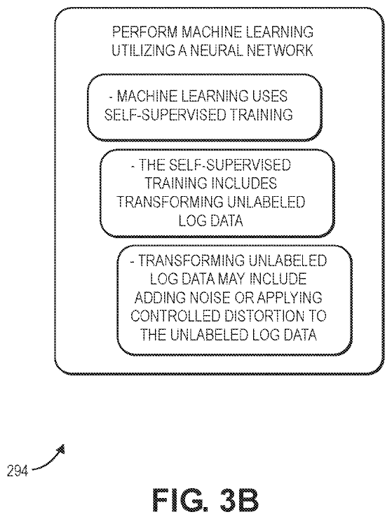

FIG. 3A is a flow diagram of a process 290 that may be used for implementing a downstream application based on a foundational model. The process 290 begins with a computing system 254 obtaining unlabeled log data (block 292). For instance, the unlabeled log data may be acquired from the sensor(s) 24 of the wireline tool 14 and/or the wellbore 16, as described in FIG. 1. Additionally or alternatively, the unlabeled log data may be from multiple wellbores, multiple oilfields, and/or multiple geographic locations. In some embodiments, the data acquired from the sensor(s) 24, as described in FIG. 1, may be labeled at acquisition. These labels may be removed before sending to the computing system 254, as described in FIG. 2. For instance, the labels may be removed at the surface unit 22 or another computing system 254. Alternatively, the labels may be removed within the computing system 254. In other words, the log data may be labeled when received by the computing system 254, but the computing system 254 obtains the unlabeled log data by removing the labels from the labeled log data before transmitting the unlabeled log data to the neural network(s) 264.

The neural network(s) 264, as described in FIG. 2, can construct a foundational model from the unlabeled log data (block 294). As illustrated in FIG. 3B, constructing the foundational model includes performing machine learning that may utilize one or more neural networks. This machine learning may be trained with self-supervised tasks at scale on a large and varied data set which includes the unlabeled log data. Multiple different types of measurements from one or more formations and formation types may be included in the unlabeled log data. This machine learning may comprise a deep model with high capacity. As discussed in greater detail hereinbelow, the self-supervised training tasks may include transforming the unlabeled log data. Examples of such transformation include adding noise to the data and applying a controlled distortion to the data. In some embodiments, adding noise before or after applying distortion to the data may comprise a transformation of the unlabeled log data.

Examples of sources of unlabeled log data may include neutron porosity (NPOR) logs, gamma ray (GR) logs, compressional slowness (DTC), shear slowness (DTS), bulk density (RHOB) logs, spontaneous potential (SP) logs, caliper (CALI) logs, shallow resistivity (LLS) logs, deep induction (ILD) logs, photoelectric (PEF) logs, and/or any other suitable log types that may be used in performing any suitable downstream applications that may be desirable in relation to wellbores 16. Compressional slowness is an alternative name for transit time of compressional waves or delta T compression (DTC). Shear slowness is an alternative name for transit time of shear waves or delta T of shear.

Constructing the foundational model may include the gathering of the data (e.g., well logs) at scale, training the foundational model, and evaluating the foundational model's performance. The training and evaluating may be recursive. Training/evaluation may use self-supervised paradigms that incorporate statistical analysis, domain-driven alterations, and derived curves from the input well logs to force the foundational model to learn representations of the well logs. For instance, the domain-driven alterations may include injecting synthetic error (e.g., noise) into extracted sections of the well logs (e.g., using the processor(s) 256). The injected error may be representative of one or more types of systematic measurement error that may be experienced in well logs. For example, such errors may include lateral shift for neutron and gamma ray logs, scaling for gamma ray logs, small vertical shifts for one or more logs, synthetic alterations, resampling borehole effect on density and neutron porosity logs, more generally multiplicative and additive noise based on one or more probability distributions. Similarly, the statistical analysis may include attempting to make predictions of parameters using a portion of the data (e.g., in past parameters using present data in a log, in future parameters using present data in a log, or a combination of using past and future data to predict present missing data, and so forth). For instance, if the predictions can be verified in the data, the prediction may be evaluated to determine the accuracy of the foundational model. Such tweaks and/or predictions may continue to further improve the foundational model until a target time and/or convergence (when training loss settles to within an error range of a final value or additional training will not improve the foundational model further) is reached. Once the foundational model is constructed, the resulting data/algorithm may be saved and stored to any suitable location, such as the database 276. Additionally or alternatively, the foundational model may be stored in a computing system 254 of a surface unit 22 that may not have a robust Internet connection due to the potentially remote nature of oilfields.

The computing system 254 storing or having access to the foundational model then fine-tunes the foundational model for a downstream application (block 296). In other words, the computing system 254 adapts the foundational model to solve for specific tasks. Indeed, the foundational model may be broadly applicable to multiple different (and even unrelated) downstream tasks. The fine-tuning may be used to refine the foundational model for one of multiple available downstream tasks that may be used to solve specific wellbore log problems. For instance, the multiple available downstream tasks may include, but not be limited to, outlier detection, wellbore log correlation to correlate new incoming data to a type of log or characteristic, correcting wellbore log errors, performing formation estimation of specific properties, performing zonation, predicting missing basic and advanced wellbore log data for one or more intervals, marking boundaries between zones, and/or any other tasks related to the log data.

Refining/fine-tuning the foundational model may include adapting the foundational model to solve for specific tasks. The refinement enables the computing system 254 to implement at least one of the downstream applications based at least in part on the foundational model (block 298). The method 290 may also include a control signal being sent by or responsive to the fine-tuned foundational model, the control signal may request or require the performance of a physical wellsite action (block 299). Responsive to the control signal, the physical wellsite action is taken, either automatically or by human intervention. The wellsite action may be based upon the one or more results, the equipment and processes, or a combination thereof. The wellsite action may be or include generating and/or transmitting a control signal (e.g., using a computing system) that causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

Implementing the downstream application using the fine-tuned foundational model takes advantage of the features and information extraction inherent in the foundational model and permits employing a wide variety of learning paradigms for specific tasks at hand. For instance, the implementation of the downstream application allows for use of supervised approaches, use of a small, labeled dataset (few-shot learning) approach, classification, self-supervised approaches such as log corrections, and unsupervised clustering, among other possibilities. The refinement and/or implementation may use the addition of new data types or new datasets, changes in the model structure, and/or retraining of part or all the weights from the foundational model. However, compared to traditional techniques, where the deep network is fully trained from the start, the fine-tuned network based in the foundational model presents faster convergence, higher stability, better generalization, reduced risk of overfitting in small training data, and in many cases includes increased accuracy. Further, a single pre-trained foundational model provides an opportunity for better streamlining of log workflows using the common foundation of the foundational model. In other words, the foundational model enables a “head start” on the specific downstream applications enabling more streamlined processing and performance of the downstream tasks. It also enables the reusage of all or most of the weights from the foundational model by keeping them unaltered (freezing them) and using in context learning, few-shot learning, and soft prompt techniques when solving multiple downstream applications. Performance of a wellsite action will have some overlapping results as implementing the downstream application, as presented here.

The faster convergence and the reduced risk of overfitting in the presence of smaller amounts of data also may enable: more user interaction for exploration and discovery in wellbore log-related products due to a smaller and more manageable data set and deploying lighter computational solutions in locations (e.g., oilfield) without high connectivity or access to a server with high computational capacity. Another advantage of using the foundational model is the ability to generalize the solution across different fields, different acquisition tools, and the ability to be incorporated into multiple downstream tasks related to wellbore logs.

Construction of a Foundational Model from Captured Data

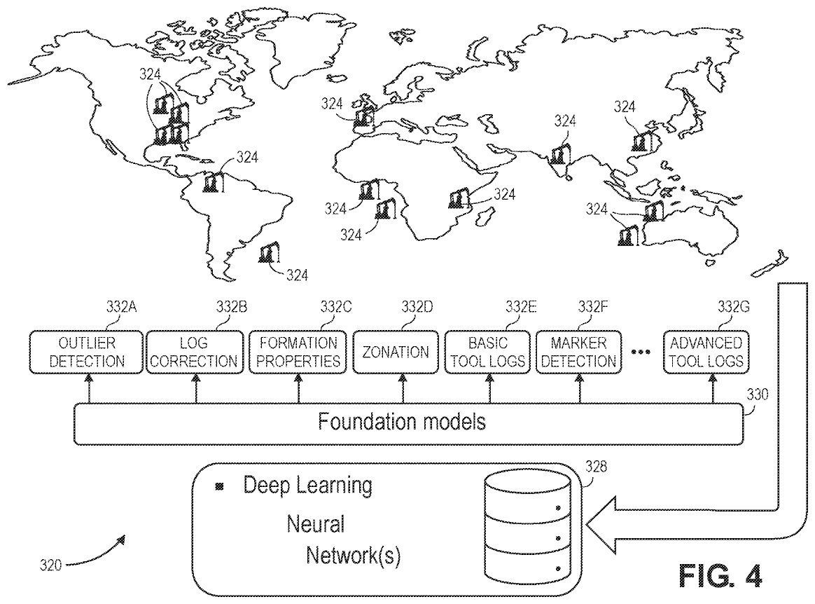

FIG. 4 is a graphical diagram of the process 320. As shown in the process 320, unlabeled wellbore data may be derived from one or more wellbore locations 324 of multiple wellbores, from one or more different oilfields, from one or more different geographic locations, and/or from one or more different oilfield service organizations. As previously noted, this wellbore data may be from a variety of different log types suitable for a variety of different downstream applications. Aggregated and unlabeled wellbore log data 326 from the one or more different wellbores, from the one or more different oilfields, from the one or more different geographic locations, and/or from the one or more different oilfield service organizations is transmitted to one or more deep learning neural networks 328 that is used to construct foundational model(s) 330. As previously noted, when the foundational model(s) 330 are to be used for downstream applications, the foundational model(s) 330 are adjusted for the particular task. For instance, the downstream tasks may include, but not be limited to, outlier detection 332A, log correction 332B, formation properties 332C, zonation 332D, basic tool logs 332E, marker detection 332F, and advanced tool logs 332G (collectively referred to downstream applications 332). Outlier detection 332A may refer to using the foundational model to detect outlier points that do not fit within normal or expected statistical distributions of the dataset that may be attributable to sensor or measurement errors, data sampling errors, wrong labels on data, unexpected results, and/or other issues, such as washed-out boreholes, tool and/or sensor issues, rare geological features, or other issues in the data acquisition process. These outliers are to be detected and investigated to determine the cause of such outliers. Log correction 332B may be used to correct log data using the foundational model(s) 330 to correct for any noise/issues that may be trained into and/or identifiable using the foundational model(s) 330. Formation properties 332C may include determining properties of a formation of a wellbore 16 from a well log analyzed using the foundational model(s) 330. Zonation 332D may include determining zones of interest (e.g., cap rock above reservoir) in/near wells by analyzing well log using the foundational model(s) 330. Similarly, marker detection 332F may be used to detect markers for such zones of interest, such as a peak of a reservoir. The foundational model(s) 330 may be also used to fill in missing data from basic tool logs 332E and/or advanced tool logs 332G. Basic tool logs may refer to directly measurable data (e.g., compression and sonic logs) while advanced tool logs may refer to less frequently acquired measurements, such as acquired from nuclear magnetic resonance (NMR), nuclear spectroscopy, and dielectric tools.

Construction of a Foundational Model from Downstream Applications

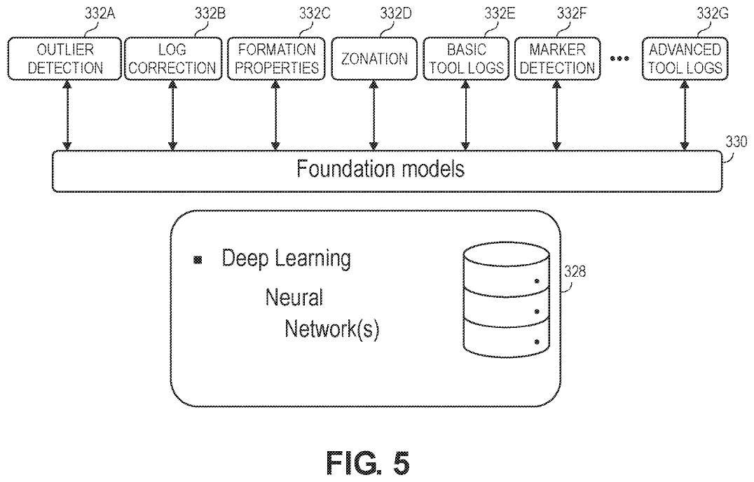

Although the foregoing discusses that the foundational model(s) 330 are derived from a variety of well logs to perform one or more downstream applications 332, as illustrated in FIG. 5, the foundational model(s) 330 may be constructed using the data from the one or more downstream applications 332 when there is a robust amount of data from the one or more downstream applications using well logs. In other words, one or more well logs may be used to perform one or more downstream applications 332 from the well logs. The data resulting from the one or more downstream applications 332 may then be used to construct a foundational model 330 similar to how the foundational model(s) 330 are constructed as previously discussed in relation to FIG. 4.

Regardless of whether the foundational model(s) 330 are constructed directly using well log data or from downstream applications 332, the foundational model(s) 330 provide an improvement due to the reusability of a deep learning method that has been trained in multiple unlabeled datasets suitable for and/or constructed from wellbore logs across different formations using self-supervised approaches. As previously discussed, the foundational model(s) 330 can learn the data representation and be used as a base building block for downstream applications 332 associated with wellbore logs. Furthermore, the foundational model(s) provide robustness, generalization, and improved computational costs over using machine learning from well logs from scratch for each downstream application 332. The reusability to solve multiple downstream applications/tasks using less labeled data, less computational time, enabling handling data with low quality, and/or enabling handling data with missing intervals or log types provides a technical advantage of performing such downstream applications 332 separately. In wellbore log applications, these advantages increase the ranges of applications to oilfields without extensive labeled data and/or access to servers or clouds with extensive processing and/or storage resources. The advantages also enable the development of products that account for user feedback on the go to provide more robust solutions and increase acceptance from experts due to the much more manageable amount of data used to perform the downstream applications 332 using the foundational model(s) 330. While embodiments have been described herein, those skilled in the art, having benefit of this disclosure, will appreciate that other embodiments are envisioned that do not depart from the scope of this application. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

What is claimed:

1. A method for optimizing one or more downstream applications, comprising:
obtaining unlabeled log data from a plurality of wellbores;
constructing a foundational model from the unlabeled log data, wherein the foundational model comprises a neural network to perform machine learning using self-supervised training, wherein the self-supervised training includes transforming the unlabeled log data;
fine-tuning the foundational model for the one or more downstream applications, wherein the downstream application is performable using the foundational model; and
implementing the one or more downstream applications based at least in part on the fine-tuned foundational model.

2. The method of claim 1, wherein the unlabeled log data comprises log data from at least one of gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, and photoelectric (PEF) logs.

3. The method of claim 1, wherein transforming the unlabeled log data includes adding noise to the unlabeled log data.

4. The method of claim 1, wherein transforming the unlabeled log data comprises applying controlled distortion to the unlabeled log data.

5. The method of claim 1, wherein constructing the foundational model also comprises utilizing a high-capacity deep learning model that includes a plurality of convolutional layers.

6. The method of claim 5, wherein the plurality of convolutional layers comprises twenty or more convolutional layers.

7. The method of claim 1, wherein the downstream applications comprise at least one of an outlier detection operation, a log correction application to correct log data by identifying mislabeling in the additional well log data, a formation property determination of a formation around a well corresponding to the unlabeled log data, determining areas of interest in the formation, marking areas of interest in the formation, and predicting missing log data from the unlabeled log data.

8. The method of claim 1, further comprising displaying the fine-tuned foundational model.

9. A computing system, comprising:
one or more processors; and
a memory system comprising one or more non-transitory computer-readable media storing instructions that, when executed by at least one of the one or more processors, cause the computing system to perform operations, the operations comprising:
obtaining unlabeled log data from a plurality of wellbores, the unlabeled log data includes data from a plurality of different log types comprising at least one of gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, orphotoelectric (PEF) logs;
constructing a foundational model from the unlabeled log data, the foundational model utilizing a neural network to perform machine learning using self-supervised training, wherein the self-supervised training comprises transforming the unlabeled log data, wherein constructing the foundational model also comprises utilizing a high-capacity deep learning model that includes a plurality of convolutional layers;
fine-tuning the foundational model for the one or more downstream applications performable using the foundational model, wherein the downstream application comprises at least one of an outlier detection operation, a log correction application to correct log data by identifying mislabeling in the additional well log data, a formation property determination of a formation around a well corresponding to the unlabeled log data, determining areas of interest in the formation, marking areas of interest in the formation, and predicting missing log data from the unlabeled log data; and
implementing the one or more downstream applications based at least in part on the foundational model.

10. The computing system of claim 9, wherein the fine-tuning includes imposing constraints on the foundational model.

11. The computing system of claim 9, wherein transforming the unlabeled log data includes adding noise to the unlabeled log data.

12. The computing system of claim 9, wherein transforming the unlabeled log data comprises applying controlled distortion to the unlabeled log data.

13. A non-transitory computer-readable medium storing instructions that, when executed by one or more processors of a computing system, cause the computing system to perform operations, the operations comprising:
obtaining unlabeled log data including unlabeled log data from at least one of gamma ray (GR) logs, neutron porosity (NPOR) logs, transit time of compressional wave (DTC) logs, transit time of shear wave (DTS) logs, bulk density (RHOB) logs, spontaneous potential (SP) logs, caliper (CALI) logs, shallow resistivity (LLS) logs, deep induction (ILD) logs, and photoelectric (PEF) logs;
constructing a foundational model from the unlabeled log data, wherein the foundational model comprises a neural network to perform machine learning using self-supervised training;
fine-tuning the foundational model for the one or more downstream applications, wherein the downstream application is performable using the foundational model; and
implementing the one or more downstream applications based at least in part on the fine-tuned foundational model.

14. The non-transitory computer-readable medium of claim 13, wherein the self-supervised training includes transforming the unlabeled log data.

15. The non-transitory computer-readable medium of claim 14, wherein transforming the unlabeled log data includes adding noise to the unlabeled log data.

16. The non-transitory computer-readable medium of claim 14, wherein transforming the unlabeled log data comprises applying controlled distortion to the unlabeled log data.

17. The non-transitory computer-readable medium of claim 13, wherein constructing the foundational model also comprises utilizing a high-capacity deep learning model that includes a plurality of convolutional layers.

18. The non-transitory computer-readable medium of claim 17, wherein the plurality of convolutional layers comprises twenty or more convolutional layers.

19. The non-transitory computer-readable medium of claim 13, wherein the downstream applications comprise at least one of an outlier detection operation, a log correction application to correct log data by identifying mislabeling in the additional well log data, a formation property determination of a formation around a well corresponding to the unlabeled log data, determining areas of interest in the formation, marking areas of interest in the formation, and predicting missing log data from the unlabeled log data.

20. The non-transitory computer-readable medium of claim 13, wherein the operations further comprise generating and transmitting a control signal in response to the fine-tuned foundational model, wherein the control signal causes a physical wellsite action to occur.
